(19) United States
(12) Patent Application Publication
(10) Pub. No.: US 2019/0019170 A1
(43) Pub. Date: Jan. 17, 2019

(54) SYSTEM AND METHOD FOR AUTOMATED TRANSFER TO PREVENT LOSS FROM TERMINATION OF RESOURCES

(71) Applicant: MASTERCARD INTERNATIONAL INCORPORATED, Purchase, NY (US)

(72) Inventors: Javier Krysztal, Miami, FL (US); Raphik Ouahsine, Miami, FL (US); Matias Sevi, Aventura, FL (US)

(21) Appl. No.: 15/651,898

(22) Filed: Jul. 17, 2017

(51) Int. Cl. G06Q 20/10

(52) U.S. Cl. CPC G06Q 20/10

(57) ABSTRACT

A method for automated transfer to prevent loss from termination of resources comprises the step of receiving, from a program manager and via an API, a resource identifier of a resource, a cessation date of the resource, and a selected cessation target. The method includes generating a transfer rule for transferring reserves associated with the resource to the cessation target on the cessation date. The transfer rule is invoked on the cessation date to transfer the reserves to the cessation target.

### BACKGROUND

A resource issued to a user has associated therewith reserves and a cessation date. The user may fail to exhaust the reserves by the cessation date, and the resource may be terminated. Termination of the resource on the cessation date may render the user unable to use any remaining reserves, resulting in a loss.

### SUMMARY

The systems and methods disclosed herein may, among other things, allow for automated transfers to prevent loss from termination of resources.

In an embodiment, a method for automated transfer to prevent loss from termination of resources comprises the step of receiving, from a program manager and via an API, a resource identifier of a resource, a cessation date of the resource, and a selected cessation target. The method includes generating a transfer rule for transferring reserves associated with the resource to the cessation target on the cessation date. The method comprises invoking the transfer rule on the cessation date to transfer the reserves to the cessation target.

In another embodiment, a system for automating transfers to prevent loss from termination of a resource having associated therewith a resource identifier and a cessation date comprises a program manager having an API. The program manager is configured to receive the resource identifier, the cessation date, and a cessation target. The system includes an online structure in communication with the program manager. The online structure has a rules database and a rule evaluator. The rules database has a transfer rule for transferring reserves associated with the resource to the cessation target on the cessation date. The rule evaluator is configured to invoke the transfer rule on the cessation date to transfer the reserves to the cessation target.

In yet another embodiment, a non-transitory computer readable medium with computer executable instructions stored thereon executed by a digital processor to perform the method of automating transfers to prevent loss from termination of resources comprises instructions for receiving, from a program manager and via an API, a resource identifier of a resource, a cessation date of the resource, and a selected cessation target. The computer readable medium includes instructions for generating a transfer rule for transferring reserves associated with the resource to the cessation target on the cessation date. The computer readable medium also has instructions for invoking the transfer rule on the cessation date to transfer the reserves to the cessation target.

### BRIEF DESCRIPTION OF THE FIGURES

FIG. 1 shows one example system for automating transfers to prevent loss from termination of a native resource, in an embodiment.

FIG. 2 shows a flowchart illustrating an example method of using the system of FIG. 1 to automate transfers to prevent loss from the termination of the native resource, in an embodiment.

FIG. 3 shows one example system for automating transfers to prevent loss from termination of a non-native resource, in an embodiment.

FIG. 4 shows a flowchart illustrating an example method of using the system of FIG. 3 to automate transfers to prevent loss from the termination of the non-native resource, in an embodiment.

### DETAILED DESCRIPTION OF THE EMBODIMENTS

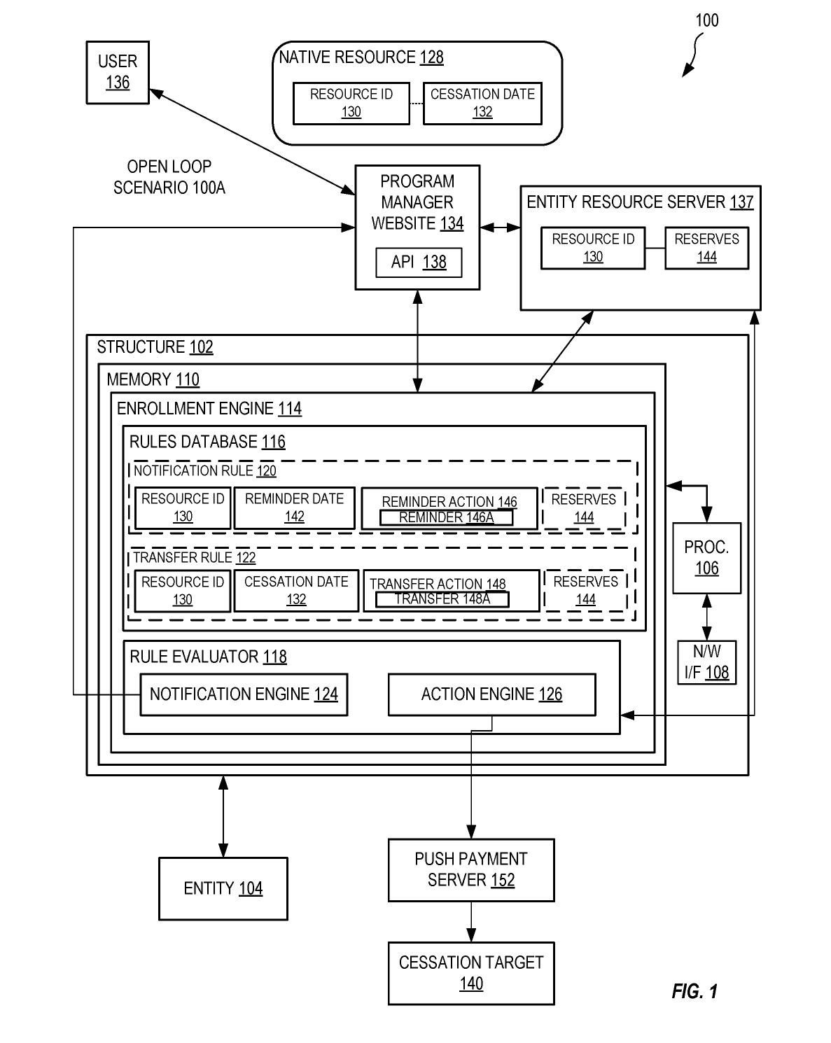

FIG. 1 shows an example system 100 for automating transfers to prevent loss from termination of resources through an online structure 102. The online structure 102 may be owned by, or operated by or on behalf of, an entity 104.

Online structure 102 may be implemented by one or more networked computer servers, and is shown with a processor 106 communicatively coupled to a network interface 108 and a memory 110. Processor 106 represents one or more digital processors. Network interface 108 may be implemented as one or both of a wired network interface and a wireless network interface, as is known in the art. Memory 110 represents one or more of volatile memory (e.g., RAM) and non-volatile memory (e.g., ROM, FLASH, magnetic media, optical media, et cetera). Although shown within online structure 102, memory 110 may be, at least in part, implemented as network storage that is external to structure 102 and accessed via network interface 108.

Enrollment engine 114 may be stored within a transitory or non-transitory portion of the memory 110. Enrollment engine 114 includes machine readable instructions that are executed by processor 106 to perform the functionality of structure 102 as described herein. In the illustrated embodiment, the enrollment engine 114 includes a rules database 116 and a rule evaluator 118. The rules database 116 includes a notification rule 120 and a transfer rule 122. The rule evaluator 118 includes a notification engine 124 and an action engine 126. The rule evaluator 118 evaluates the rules database 116 to determine if either of the notification rule 120 and the transfer rule 122 is to be invoked. If the rule evaluator 118 determines that the notification rule 120 is to be invoked, the rule evaluator 118 calls the notification engine 124 to implement the notification rule 120. If the rule evaluator 118 determines that the transfer rule 122 is to be invoked, the rule evaluator 118 calls the action engine 126 to implement the transfer rule 122.

The system 100 is configured to automate transfers to prevent loss from termination of a native resource 128. The native resource 128 is one that is issued by (or otherwise associated with) the entity 104. The native resource 128 has a resource identification number 130 and a cessation date 132. While FIG. 1 shows one native resource 128, the artisan will understand that the system 100 may also be used to automate transfers to prevent loss from termination of any number of native resources.

Enrollment engine 114 is in data communication, e.g., over a wired and/or wireless network, with a program manager website 134. The program manager website 134 is a secure (e.g., an encrypted, password protected, etc.) website and has an application programming interface (API) 138. The API 138 facilitates communication between the program manager website 134 and other components and users of the system 100.

User 136 is an individual who owns the native resource 128, e.g., to whom the native resource 128 is issued by the entity 104, or another individual authorized to use the native resource 128. The program manager website 134 allows the user 136 to interact with the online structure 102. The user 136 may access the program manager website 134 via a computing device (such as a desktop computer, laptop computer, smart phone, etc. (not expressly shown)) to enroll the native resource 128 with the enrollment engine 114.

In an embodiment, to enroll the native resource 128 with the enrollment engine 114, the user 136 uses a mobile or other computing device to provide to the program manager website 134 the resource identification number 130 and the cessation date 132 of the native resource 128. During the enrollment process, the user 136 may further identify one or more cessation targets 140 and a reminder date 142. The reminder date 142 may be thirty (or a different number) of days prior to the cessation date 132. In embodiments, the program manager website 134 may automatically set the reminder date 142 for the native resource 128 (e.g., the program manager website 134 may automatically set the reminder date 142 to be thirty (or a different predefined number of) days before the cessation date 132). The resource identification number 130, reminder date 142, cessation date 132, and cessation targets 140 may be stored in the memory 110, e.g., in the rules database 116.

The program manager website 134 and the enrollment engine 114 may each selectively communicate with an entity resource server 137. The entity resource server 137 is native to the entity 104, e.g., is created and/or operated by or on behalf of the entity 104. The entity resource server 137 contains a log of the current reserves 144 of the native resource 128 and other native resources. For example, as shown, the entity resource server 137 may include the resource identification number 130 of the native resource 128 indexed to the current reserves 144 thereof.

The rule evaluator 118 may determine if either of the notification rule 120 and the transfer rule 122 in the rules database 116 is to be invoked. The notification rule 120 may include the resource identification number 130 and the reminder date 142. As discussed herein, the notification rule 120 may specify that a reminder action 146 is to be taken on the reminder date 142 if the reserves 144 of the native resource 128 on the reminder date 142 are non-zero (or alternately, are above a predefined amount). The enrollment engine 114 may communicate with the entity resource server 137 on the reminder date 142 to determine the reserves 144 of the native resource 128 on the reminder date 142. If the rule evaluator 118 determines that the reserves 144 on the reminder date 142 are non-zero (or alternately, are above a predefined amount) such that the reminder action 146 is to be taken, the rule evaluator 118 may call the notification engine 124 to communicate a reminder 146A to the user 136. The reminder 146A may be one or more of an e-mail, a text message, a voice message, etc. In an embodiment, the notification engine 124 may communicate the reminder 146A to the user 136 via the program manager website 134. In some embodiments, the program manager website 134 may generate a reminder notification on the reminder date 142 and communicate same to the user 136.

The transfer rule 122 in the rules database 116 may include the resource identification number 130 and the cessation date 132. As described below, the transfer rule 122 may specify that a transfer action 148 is to be taken on the cessation date 132 if the reserves 144 of the native resource 128 on the cessation date 132 are non-zero (or alternately, are above a predefined amount). The enrollment engine 114 may communicate with the entity resource server 137 on the cessation date 132 to determine the reserves 144 of the native resource 128 on the cessation date 132. If the rule evaluator 118 determines that the reserves 144 of the native resource 128 on the cessation date 132 are non-zero (or alternately, are above a predefined amount) such that the transfer action 148 is to be taken, the rule evaluator 118 may invoke the action engine 126 to effectuate a transfer 148A of these reserves 144 from the native resource 128 to the cessation target(s) 140. Specifically, the action engine 126 may call a push payment server 152 to transfer any reserves 144 in the native resource 128 on the cessation date 132 to the cessation target(s) 140 specified by the user 136.

The native resource 128 may be, for example, a prepaid card issued by the entity 104 to the user 136 (or to another person who has in-turn authorized the user 136 to use the native resource 128). For example, the entity 104 may be Mastercard International Incorporated, and the native resource 128 may be a Mastercard® prepaid debit card. Or, for instance, the entity 104 may be a bank and the native resource 128 may be a prepaid debit card issued by that bank.

Prepaid cards, such as the native resource 128, are ubiquitous. Indeed, the prepaid card industry is a billion dollar industry in the U.S. alone. An individual, such as the user 136, may own or otherwise be authorized to use several different resources (e.g., native resource 128 and other such resources) native to the entity 104. Each native resource 128 may have a unique resource identification number 130 (e.g., a fourteen to sixteen digit primary account number (“PAN”)) and a cessation date 132 (e.g., an expiration date or a point in time (such as midnight) on the expiration date). The PAN 130 may be encoded in the magnetic strip of the native resource 128 and may, among other things, identify the entity 104 that issued the native resource 128 and the account number (e.g., an identification number) associated therewith. The resource identification number or PAN 130 may also be referred to herein as the primary identification number 130.

The user 136 typically has no easy way to keep track of the cessation date 132 of the native resource 128. Resultantly, reserves 144 that remain in the native resource 128 on the cessation date 132 may thereafter be unusable by the user 136, which is undesirable. The system 100 may serve to proactively remind the user 136 (e.g., on the reminder date 142) that the cessation date 132 of his unexhausted native resource 128 is approaching, and if the reserves 144 are not exhausted by the cessation date 132, the system 100 may automatically cause the reserves remaining in the native resource 128 on the cessation date 132 to be transferred to one or more cessation targets 140 chosen by the user 136.

The entity resource server 137 may include the resource identification number 130 of the native resource 128, and the reserves 144 currently associated therewith. For example, if the entity 104 is a bank that has issued the prepaid card 128, the entity resource server 137 may be a server set up by the bank to manage the amount of monies associated with the native resource 128. The entity resource server 137 may periodically update the reserves 144 in line with the use of the native resource 128 by the user 136. For instance, if the native resource 128 was issued with $100, and the user 136 uses $40, the entity resource server 137 may indicate that the reserves 144 of the native resource 128 are $60.

The cessation target 140 may be any entity (e.g., individual, institution, or company) selected by the user 136 to receive the reserves 144 remaining in the native resource 128 on the cessation date 132. In an embodiment, the cessation target 140 may be a charity or other non-profit institution. Conveyance of any remaining reserves 144 on the cessation date 132 to a charity or non-profit institution may allow reserves 144 that would have otherwise been unavailable to the user 136 to be applied towards a good cause. The user 136 may also find it desirable to convey the reserves 144 on the cessation date 132 to the charity or non-profit organization 140 because such may provide tax benefits to the user 136. In some embodiments, the program manager website 134 may include a list of approved cessation targets 140, and the user 136 may be allowed to select a cessation target 140 from the approved list. It is envisioned that, in embodiments, the user 136 may be able to use the program manager website 134 to select two or more cessation targets 140; in these embodiments, the user 136 may also be able to specify a percentage of the reserves 144 that is to be sent to each of the different cessation targets 140 on the cessation date 132.

The push payment server 152 may be any server that supports online money transfers. In embodiments, the push payment server 152 may be native to the entity 104 (e.g., where the entity 104 is Mastercard International Incorporated, the push payment server 152 may be Mastercard's personal payments application server). In other embodiments, the push payment server 152 may be unaffiliated with the entity 104 (e.g., the entity 104 may be Mastercard International Incorporated and the push payment server 152 may be a server maintained by PayPal® or another online money transfer service).

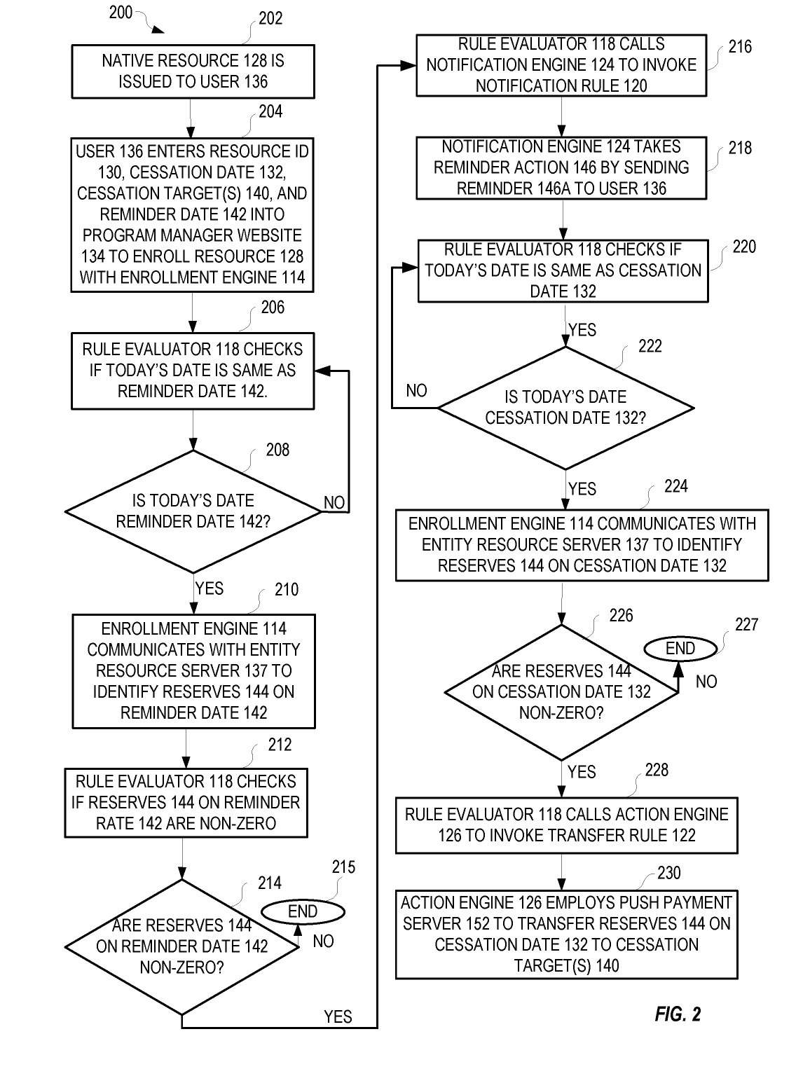

FIG. 2 shows an example method 200 of using the system 100 for automating transfers to cessation target(s) 140 to prevent loss from termination of the native resource 128. The artisan will appreciate from the discussion herein that not all steps of the method 200 need to be performed in the order described, and that in embodiments, one or more steps of the method 200 may be omitted or combined with other steps.

At step 202, the entity 104 (e.g., a bank, a financial services corporation, etc.) may issue the native resource 128, such as a prepaid card, to the user 136. For the purposes of illustration, assume that the native resource 128 is issued by the entity 104 on May 1, 2017 with a balance of $100, and expires on Jul. 1, 2017. Assume further that the user 136 wishes for any funds remaining in the native resource 128 on the cessation date 132 to be transferred to the Red Cross.

At step 204, the user 136 may use the program manager website 134 to enroll the native resource 128 with the enrollment engine 114. Specifically, at step 204, the user 136 may enter the resource identification number 130, the cessation date 132, the cessation target(s) 140, and the reminder date 142 into the program manager website 134 to enroll the native resource 128 with the enrollment engine 114. For instance, the user 136 may enter into the program manager website 134: the unique sixteen digit reference identification number 130 of the native resource 128, a cessation date 132 of Jul. 1, 2017, a reminder date 142 of Jun. 1, 2017, and a cessation target 140 of Red Cross. As discussed above, in some embodiments, the user 136 may be allowed to select two or more cessation targets 140, and may further be allowed to specify the percentage of the reserves 144 that are to be transferred to each cessation target 140 on the cessation date 132 (e.g., the user 136 may specify that the cessation targets 140 are Red Cross and the Salvation Army, and that 60% of the reserves 144 on the cessation date 132 are to be transferred to the Red Cross and the remainder are to be transferred to the Salvation Army). While not required, in some embodiments, the entity 104 may as part of the enrollment process, charge the user 136 a fee for his or her use of the services provided by the system 100.

Once the enrollment process is complete, at step 206, the rule evaluator 118 may check whether the present day's date is the same as the reminder date 142. If the present day's date is the same as the reminder date 142 (i.e., Jun. 1, 2017 in this example) as determined at step 208, the method 200 may move to step 210. Otherwise, the method 200 may loop back from step 208 to step 206 until the present day's date is the same as the reminder date 142.

If at step 208 the rule evaluator 118 determines that the present day's date is the reminder date 142, at step 210, the enrollment engine 114 may communicate with the entity resource server 137 to identify the current reserves 144 of the native resource 128. At step 212, the rule evaluator 118 may determine if the reserves 144 on the reminder date 142 are greater than zero. Assume, for example, that the user 136 has spent $50 since May 1, 2017, and that the reserves 144 on Jun. 1, 2017, are $50. If the rule evaluator 118 determines at step 214 that the reserves 144 on the reminder date 142 are greater than zero, the rule evaluator 118 may call the notification engine 124 at step 216 to invoke the notification rule 120. Alternately, had the user 136 exhausted the reserves 144 by the reminder date 142 at step 214, the method 200 may have ended at step 215.

If the reserves 144 on the reminder date 142 are non-zero, the notification engine 124 may take the reminder action 146 at step 218. Specifically, at step 218, the notification engine 124 may send the reminder 146A to the user 136, e.g., directly or via the program manager website 134. The reminder 146A may, in embodiments, include the reserves 144 on the reminder date 142. In some embodiments, the reminder 146A may also include a listing of the cessation target(s) 140 and/or the cessation date 132. For instance, in this example, the reminder 146A may outline that the native resource 128 has $50 in reserves on the reminder date 142 and further outline that any remaining reserves 144 will be transferred to the Red Cross on Jul. 1, 2017. While not expressly shown in FIG. 2, the user 136 may change his preferences in response to the reminder 146A (or at a different time before the cessation date 132). For example, the user 136 may, in response to the reminder 146A or at a different time, use the program manager website 134 to specify that the reserves 144 are to be transferred to a cessation target other than the cessation target 140 initially identified by the user 136 during the enrollment process. In some embodiments, the user 136 may use the program manager website 134 to set additional reminders (e.g., the user 136 may use the program manager website 134 to set an additional reminder two weeks before the cessation date 132).

Once the notification rule 120 has been invoked, the rule evaluator 118 may periodically (e.g., once a day) check whether the transfer rule 122 is to be invoked. Specifically, at step 220, the rule evaluator 118 may check if today's date is the same as the cessation date 132. If the rule evaluator 118 determines at step 222 that today's date is the same as the cessation date 132 (e.g., today's date is Jul. 1, 2017), the method 200 may move to step 224. Alternately, if the reminder date 342 has passed and the cessation date 332 has not arrived, the method 200 may loop back to step 220 until the present day's date is the same as the cessation date 132.

If the rule evaluator 118 determines at step 222 that the present day's date is the same as the cessation date 132, at step 224, the enrollment engine 114 may communicate with the entity resource server 137 to identify the reserves 144 on the cessation date 132. At step 226, the rule evaluator 118 may determine if the reserves 144 on the cessation date are non-zero. If the reserves 144 have been exhausted, the method 200 may end at step 227. Alternately, if the present day's date is the same as the cessation date 132 and the current reserves 144 are non-zero, the rule evaluator 118 may at step 228 call the action engine 126 to invoke the transfer rule 122. Assume, for example, that the user 136 used another $20 from the native resource 128 since the reminder date 142 and that the reserves 144 thereof on the cessation date are $30.

At step 230, the action engine 126 may employ the push payment server 152 to transfer the current reserves 144 on the cessation date 132 to the cessation target 140. For instance, in this example, the action engine 126 may cause the push payment server 152 to transfer $30 to the Red Cross on Jul. 1, 2017. In embodiments, identification information associated with the native resource 128 (e.g., the resource identification number 130) may also be furnished to the cessation target 140.

In this way, thus, the system 100 may send the user 136 a timely reminder regarding the current reserves 144 of the native resource 128 and may further automate transfers to cessation target(s) 140 to prevent loss from termination of the native resource 128.

While the disclosure above describes the cessation target 140 as a charity or non-profit and describes the cessation date 132 as an expiration date of the native resource 128, the artisan will understand that such is merely exemplary. For instance, the user 136 may identify any individual or corporation as the cessation target 140. Similarly, the cessation date 132 may be a date other than the expiration date of the native resource 128 (e.g., the cessation date 132 may be a date on which a penalty is charged by the entity 104 for failure to use the native resource 128).

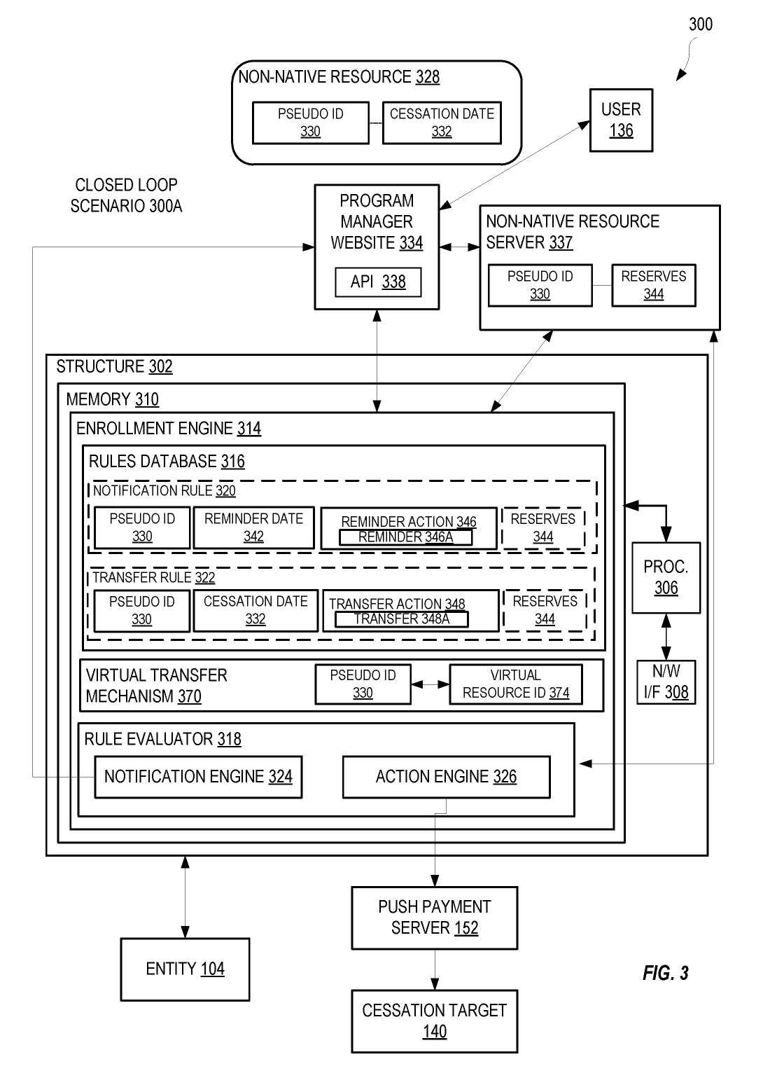

The method 200, implemented by the system 100 as detailed above, may be referred to herein as an open loop scenario 100A. In the open loop scenario 100A, the native resource 128 is native to the entity 104 that owns and/or operates the structure 102. For example, as discussed above, the entity 104 may be Mastercard International Incorporated and the native resource 128 may be a Mastercard prepaid card issued to the user 136. The user 136, however, may also possess resources that are not native to the entity 104. For example, the user 136 may have a gift card from Target®, BestBuy®, or another such non-native resource from a merchant unaffiliated with the entity 104. FIG. 3 shows a system 300 for automating transfers to prevent loss from termination of a non-native resource 328 (e.g., a gift card), according to an embodiment. The system 300 may be generally identical to the system 100, except as specifically noted and/or shown, or as would be inherent. Those skilled in the art will appreciate that the system 100 (and thus the system 300) may be modified in various ways, such as through incorporating all or part of any of the various described embodiments, for example. For uniformity and brevity, corresponding reference numbers may be used to indicate corresponding parts, though with any noted deviations.

The system 300 may include an online structure 302 that is owned or operated by or on behalf of the entity 104. The online structure 302 may be implemented as one or more networked computer servers, and is shown as having a digital processor 306 communicatively coupled to a network interface 308 and memory 310. The network interface 308 is implemented as a wired and/or wireless network interface, and the memory 310 represents one or more of volatile memory and non-volatile memory.

Enrollment engine 314 in the memory 310 includes machine readable instructions executed by the processor 306 to perform the functionality of the online structure 302 as described herein. The enrollment engine 314 includes a rules database 316, a rule evaluator 318, and a virtual transfer mechanism 370.

Akin to the rules database 116 and the rule evaluator 118, the rules database 316 includes a notification rule 320 and a transfer rule 322, and the rule evaluator 318 includes a notification engine 324 and an action engine 326. The rule evaluator 318 evaluates the rules database 316 to determine if either of the notification rule 320 and the transfer rule 322 is to be invoked. If the rule evaluator 318 determines that the notification rule 320 is to be invoked, the rule evaluator 318 calls the notification engine 324 to implement the notification rule 320. If the rule evaluator 318 determines that the transfer rule 322 is to be invoked, the rule evaluator 318 calls the action engine 326 to implement the transfer rule 322.

The non-native resource 328 has a pseudo identification number 330 and a cessation date 332. The pseudo identification number 330 is a number or an alpha-numeric string associated with the non-native resource 328 by the issuing merchant to uniquely identify the non-native resource 328 (e.g., the pseudo identification number 330 may be a 10 digit number set by a merchant that issued the gift card 328). The length and/or format of the pseudo identification number 330 may different from that of the resource identification number 130. The cessation date 332 is, for example, an expiration date of the non-native resource 328.

Enrollment engine 314 is in data communication, e.g., over a wired and/or wireless network, with a program manager website 334. The program manager website 334, in embodiments, is owned and/or operated by or on behalf of the merchant that issued the non-native resource 328. The user 136 may access the program manager website 334 to enroll the non-native resource 328 with the enrollment engine 314, as described above for the system 100. Specifically, the user 136 may enroll the non-native resource 328 with the enrollment engine 314 by entering into the program manager website 334 the pseudo identification number 330, the cessation date 332, and the reminder date 342. The user 136 may further identify one or more cessation targets 140, as described above.

The program manager website 334 and the enrollment engine 314 may each selectively communicate with the non-native resource server 337 (e.g., a server maintained by a merchant that issued the gift card 328). The non-native resource server 337 may contain a log of the current reserves 344 of the non-native resource 328.

The rule evaluator 318 may invoke the notification rule 320 on the reminder date 342 if the reserves 344 of the non-native resource 328 on this date are non-zero. If the notification rule 320 is invoked, the notification engine 324 may take a reminder action 346 and communicate a reminder 346A to the user 136. The reminder 346A may include the reserves 344 on the reminder date 342 and, in some embodiments, a listing of the cessation target(s) 140 and/or the cessation date 132. The reminder 346A may be communicated to the user 136 by the enrollment engine 314 directly or via the program manager website 334. In some embodiments, the reminder 346A may be generated and communicated to the user 136 by the program manager website 334.

The rule evaluator 318 may invoke the transfer rule 322 on the cessation date 332 if the reserves 344 of the non-native resource 328 on this date are non-zero. If the transfer rule 322 is invoked, the virtual transfer mechanism 370 may be called and may convert the pseudo identification number 330 to a virtual resource identification number 374. The virtual resource identification number 374 may be a number that uniquely identifies the non-native resource 328, and in embodiments, may have the same length and format as that of the resource identification number 130 of the native resource 128. Conversion of the pseudo identification number 330 to the virtual resource identification number 374 may allow the push payment server 152 to treat the non-native resource 328 as a conventional prepaid debit card. Once the virtual transfer mechanism 370 has converted the pseudo identification number 330 to the virtual resource identification number 374, the action engine 326 may employ the push payment server 152 to transfer the reserves 144 remaining in the non-native resource 328 on the cessation date 332 to the cessation target 140. In embodiments, the virtual transfer mechanism 370 may convert the pseudo identification number 330 to the virtual resource identification number 374 only if reserves 344 are to be transferred to the cessation target 140 on the cessation date 332,

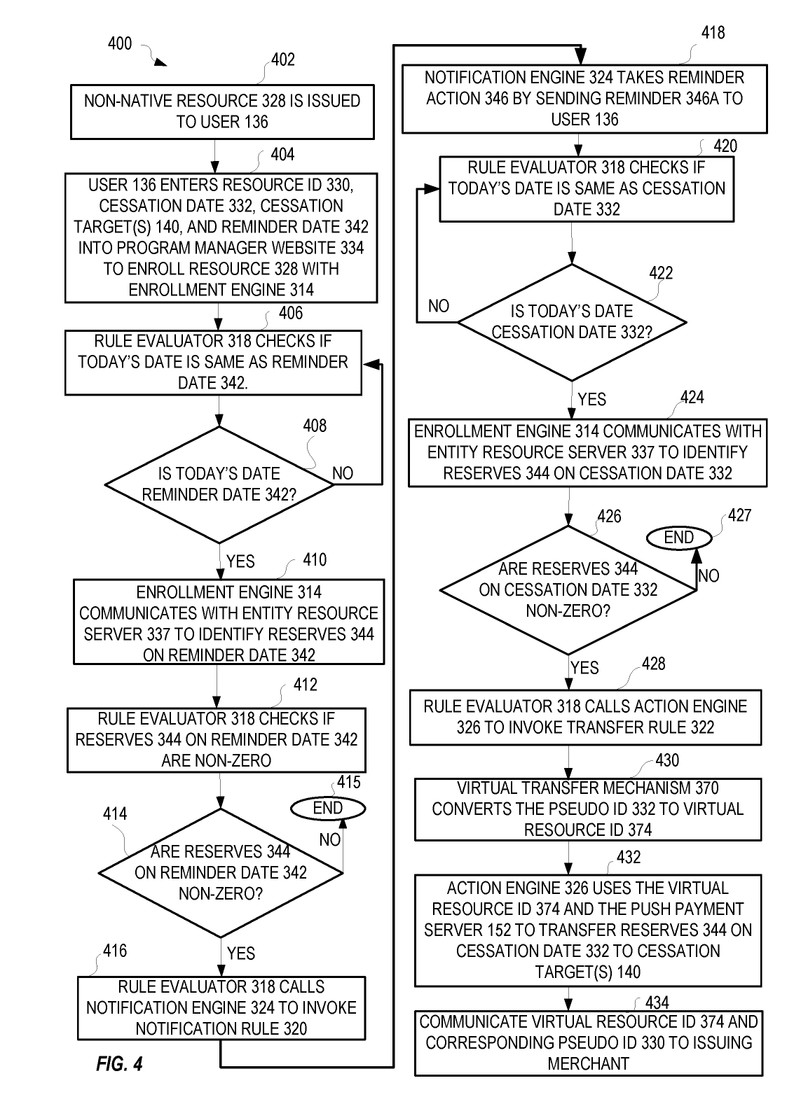

FIG. 4 shows an example method 400 of using the system 300 for automating transfers to cessation target(s) 140 to prevent loss from termination of the non-native resource 328. The artisan will appreciate from the discussion herein that not all steps of the method 400 need to be performed in the order described, and that in embodiments, one or more steps of the method 400 may be omitted or combined with other steps. The method 400 may also be referred to herein as a closed loop scenario 300A, to signify that the resource 328 is not native to the entity 104 that owns and/or operates the structure 302.

At step 402, a merchant (or a different entity other than entity 104) may issue the non-native resource 328, such as a gift card, to the user 136. For the purposes of illustration, assume that the non-native resource 328 is issued by a merchant on Jan. 1, 2016 with a balance of $50, and that the non-native resource 328 expires on Jan. 1, 2017. Assume also that the user 136 wishes for any funds remaining in the non-native resource 328 at the cessation date 332 to be transferred to the Habitat for Humanity.

At step 404, the user 136 may use the issuing merchant's program manager website 334 to enroll the non-native resource 328 with the enrollment engine 314. Specifically, at step 404, the user 136 may enter the pseudo identification number 330, the cessation date 332, the cessation target(s) 140, and the reminder date 342 into the program manager website 334 to enroll the non-native resource 328 with the enrollment engine 314. For instance, the user 136 may enter into the program manager website 334 a unique alpha-numeric string 330 selected by the issuing merchant to identify the non-native resource 328, enter Jan. 1, 2017 as the cessation date 332, enter Dec. 1, 2016 as the reminder date 342, and enter the Habitat for Humanity as the cessation target 140.

Once the enrollment process is complete, at step 406, the rule evaluator 318 may check whether the present day's date is the same as the reminder date 342. If the present day's date is the same as the reminder date 342 (i.e., Dec. 1, 2016 in this example) as determined at step 408, the method 400 may move to step 410. Otherwise, the method 400 may loop back from step 408 to step 406 until the present day's date is the same as the reminder date 342.

If at step 408 the rule evaluator 318 determines that the present day's date is the same as the reminder date 342, at step 410, the enrollment engine 314 may communicate with the non-native resource server 337 (e.g., a server maintained by the merchant that issued the non-native resource 328) to identify the current reserves 344 of the non-native resource 328. At step 412, the rule evaluator 318 may determine if the reserves 344 on the reminder date 342 are greater than zero. Assume, for example, that the user 136 has spent $20 since Jan. 1, 2016, and that the reserves 144 on Dec. 1, 2016 are $30. If the rule evaluator 318 determines at step 414 that the reserves 344 on the reminder date 342 are greater than zero, the rule evaluator 318 may call the notification engine 324 at step 416 to invoke the notification rule 320. Alternately, had the user 136 exhausted the reserves 344 by the reminder date 342 at step 414, the method 400 may have ended at step 415.

If the reserves 344 on the reminder date 342 are non-zero, the notification engine 324 may take the reminder action 346 at step 418. Specifically, at step 418, the notification engine 324 may send the reminder 346A to the user 136, e.g., directly or via the program manager website 334. The reminder 346A may include the reserves 344 on the reminder date 342, and in embodiments, a listing of the cessation target(s) 140 and/or the cessation date 332.

At step 420, the rule evaluator 318 may check if today's date is the same as the cessation date 332. If the rule evaluator 318 determines at step 422 that today's date is the same as the cessation date 332 (e.g., today's date is Jan. 1, 2017), the method 400 may move to step 424. Alternately, if the reminder date 342 has passed and the cessation date 332 has not yet arrived, the method 400 may loop back to step 420 until the present day's date is the same as the cessation date 332.

If the rule evaluator 318 determines at step 422 that the present day's date is the same as the cessation date 332, at step 424, the enrollment engine 314 may communicate with the non-native resource server 337 to identify the reserves 344 on the cessation date 332. At step 426, the rule evaluator 318 may determine if the reserves 344 on the cessation date 332 are non-zero. If no reserves 344 remain, the method 400 may end at step 427. Alternately, if the present day's date is the same as the cessation date 332 and the current reserves 344 are non-zero, the rule evaluator 318 may at step 428 call the action engine 326 to invoke the transfer rule 322. Assume, for example, that the user 136 used another $20 from the non-native resource 328 since the reminder date 342 and that the reserves 344 thereof on the cessation date 332 are $10.

At step 430, the virtual transfer mechanism 370 of the enrollment engine 314 may convert the unique pseudo identification number 330 to a unique virtual resource identification number (i.e., a virtual PAN) 374. The length and format of the virtual resource identification number 374 may correspond to the length and format of the resource identification number 130, which may allow the push payment server 152 to transfer the reserves 344 of the non-native resource 328 much like reserves from a conventional debit card would be transferred.

At step 432, the action engine 326 may employ the push payment server 152 to transfer the current reserves 344 on the cessation date 332 to the cessation target 140. For instance, in this example, the action engine 326 may cause the push payment server 152 to transfer $10 to the Habitat for Humanity on Jan. 1, 2017. At step 434, the virtual resource identification number 374, together with the corresponding pseudo identification number 330, may be communicated to the program manager website 334 so that the reserves 344 of the non-native resource 328 may be updated by the issuing merchant in the non-native resource server 337.

Thus, as has been described, the systems 100 and 300 may send the user 136 timely reminders regarding the reserves of their native and non-native resources, and may further automate transfers to cessation target(s) 140 to prevent loss from termination of the native and non-native resources. The term resource, as used herein, may refer at least to one or both of the native resource 128 and the non-native resource 328. The term resource server may refer at least to one or both of the entity resource server 137 and the non-native resource server 337.

Changes may be made in the above systems and methods without departing from the scope hereof. It should hence be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for automated transfer to prevent loss from termination of resources, comprising the steps of:
receiving, from a program manager and via an API, a resource identifier of a resource, a cessation date of the resource, and a selected cessation target;
generating a transfer rule for transferring reserves associated with the resource to the cessation target on the cessation date; and
at the cessation date, invoking the transfer rule to transfer the reserves to the cessation target.

2. The method of claim 1, the cessation target comprising identification information for receiving the reserves

3. The method of claim 1, the resource identifier comprising a primary identification number.

4. The method of claim 1, the resource identifier comprising a pseudo identification number, the method further comprising generating a virtual resource identification number corresponding to the pseudo identification number.

5. The method of claim 1, further comprising:
generating a notification rule to remind, at a first date prior to the cessation date, a user of the resource to indicate that the resource has reserves; and
at the first date, invoking the notification rule to interact with the program manager to send a notification to the user to indicate that the resource has reserves.

6. The method of claim 1, the step of invoking the transfer rule further comprising determining the reserves and, if the reserves are greater than zero, transferring the reserves to the cessation target.

7. The method of claim 1, further comprising generating a virtual resource identification number corresponding to the resource identifier in response to a determination that the reserves on the cessation date are non-zero.

8. A system for automating transfers to prevent loss from termination of a resource, the resource having associated therewith a resource identifier and a cessation date, the system comprising:
a program manager having an API, the program manager configured to receive the resource identifier, the cessation date, and a cessation target; and
an online structure in communication with the program manager; the online structure having a rules database and a rule evaluator; the rules database having a transfer rule for transferring reserves associated with the resource to the cessation target on the cessation date;
wherein, the rule evaluator is configured to invoke the transfer rule on the cessation date to transfer the reserves to the cessation target.

9. The system of claim 8, further comprising a resource server in data communication with the program manager and the online structure, the resource server indicating the reserves associated with the resource.

10. The system of claim 8, the resource identifier comprising a primary identification number.

11. The system of claim 8, the resource identifier comprising a pseudo identification number.

12. The system of claim 11, further comprising a virtual transfer mechanism configured to generate a virtual resource identification number corresponding to the pseudo identification number.

13. The system of claim 8, the rule evaluator comprising a notification engine configured to invoke a notification rule housed in the rules database on a reminder date.

14. The system of claim 13, the cessation target including two or more cessation targets.

15. A non-transitory computer readable medium with computer executable instructions stored thereon executed by a digital processor to perform the method of automating transfers to prevent loss from termination of resources, comprising:
instructions for receiving, from a program manager and via an API, a resource identifier of a resource, a cessation date of the resource, and a selected cessation target;
instructions for generating a transfer rule for transferring reserves associated with the resource to the cessation target on the cessation date; and
instructions for invoking the transfer rule on the cessation date to transfer the reserves to the cessation target.

16. The non-transitory computer readable medium of claim 15, further comprising instructions for deducting a fee prior to the invocation of the transfer rule.

17. The non-transitory computer readable medium of claim 15, the cessation target comprising identification information for receiving the reserves.

18. The non-transitory computer readable medium of claim 15, the resource identifier comprising a primary identification number.

19. The non-transitory computer readable medium of claim 15, the resource identifier comprising a pseudo identification number, the non-transitory computer readable medium further including instructions for generating a virtual resource identification number corresponding to the pseudo primary account number.

20. The non-transitory computer readable medium of claim 15, further comprising:
instructions for generating a notification rule to remind, at a first date prior to the cessation date, a user of the resource to indicate that the resource has reserves; and
instructions for invoking the notification rule on the first date to interact with the program manager to send a notification to the user to indicate that the resource has reserves.
